(19) United States
(12) Patent Application Publication
(10) Pub. No.: US 2015/0067478 A1
(43) Pub. Date: Mar. 5, 2015

(54) WEB SERVER, SYSTEM AND METHOD FOR CREATING CUSTOMIZED WEB PAGES

(71) Applicants: Fu Tai Hua Industry (Shenzhen) Co., Ltd., Shenzhen (CN); HON HAI PRECISION INDUSTRY CO., LTD., New Taipei (TW)

(72) Inventors: HAI-JUN MAO, Shenzhen (CN); CHIH-SAN CHIANG, New Taipei (TW); HAI-SEN LIANG, Shenzhen (CN); HUA-DONG CHENG, Shenzhen (CN)

(21) Appl. No.: 14/471,523

(22) Filed: Aug. 28, 2014

(30) Foreign Application Priority Data
Aug. 28, 2013 (CN) 2013103805440

(51) Int. Cl. G06F 17/30; H04L 29/08

(52) U.S. Cl. CPC G06F 17/30905; H04L 67/02
USPC 715/234

(57) ABSTRACT

A method for generating a customized web page is provided. The method includes identifying an identity of a user when the user opens a browser to browse content from a web server and obtaining partial content of the web page from the web server. The obtained partial content is associated with the user's customized topics of the web page. A customized web page is created according to the obtained partial content and the created customized web page is displayed.

### CROSS-REFERENCE TO RELATED APPLICATIONS

This application claims priority to Chinese Patent Application No. 201310380544.0 filed on Aug. 28, 2013 in the China Intellectual Property Office, the contents of which are incorporated by reference herein.

### FIELD

The subject matter herein generally relates to personalized web pages, and more particularly, to a web server, a system and a method for creating personalized web pages.

### BACKGROUND

Typically, a web server supplies a same web page for users to browse, in despite of what content the users really cares. However, a user may only care certain particular topics such as sports or news, and the user may hope the topics he or she does not care to be blocked.

### BRIEF DESCRIPTION OF THE DRAWINGS

Implementations of the present technology will now be described, by way of example only, with reference to the attached figures, wherein:

FIG. 1 is a diagrammatic view of one embodiment of a network environment in which a system for creating a personalized web page is run.

FIG. 2 is a block diagram of the system of FIG. 1.

FIG. 3 is a flowchart of an embodiment of a method for creating customized web pages.

FIG. 4 is a flowchart of another embodiment of a method for creating customized web pages, which further includes two more blocks than the flowchart of FIG. 3.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The word “module,” and “unit” as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may comprise connected logic units, such as gates and flip-flops, and may comprise programmable units, such as programmable gate arrays or processors. The modules described herein may be implemented as either software and/or hardware modules and may be stored in any type of non-transitory computer-readable storage medium or other computer storage device. The term “comprising,” when utilized, means “including, but not necessarily limited to”; it specifically indicates open-ended inclusion or membership in the so-described combination, group, series and the like.

The present disclosure is described in relation to a method, a web server and a system for creating a personalized web page. The method includes identifying identity of a user when the user opens a browser to browse content from a web server and obtaining partial content of the web page from the web server. The obtained partial content is associated with the user's customized content topics of the web page. A customized web page of the user is created according to the obtained partial content and the created customized web page is displayed via the browser. The system and the web server both include an identification unit, an obtaining unit and a control unit. The identification unit is configured for identifying identity of a user when the user opens a browser to browse content from a web server. The obtaining unit is configured for obtaining partial content of the web page from the web server, the obtained partial content being associated with the user's customized content topics of the web page. And the control unit is configured for creating a customized web page of the user according to the obtained partial content, and displaying the created customized web page.

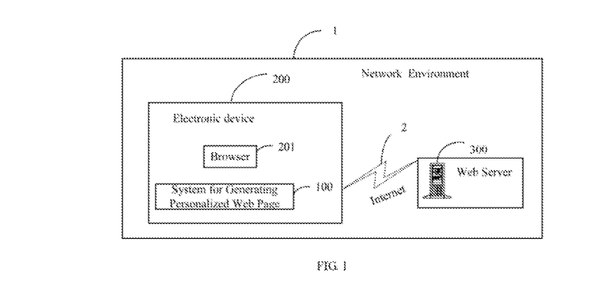

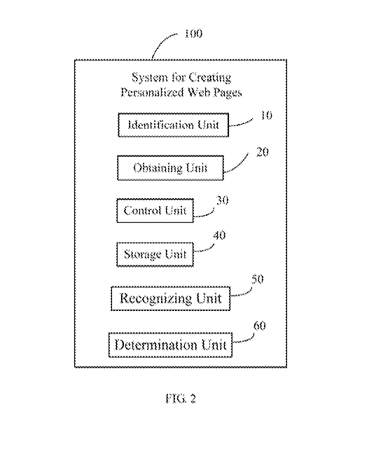

FIG. 1 illustrates a network environment 1. FIG. 2 illustrates a system 100 for generating a customized web page for a user. The system 100 can be nm in the network environment 1. The network environment 1 can include an electronic device 200 and a web server 300. The electronic device 200 communicates with the web device 300 via a network 2. The electronic device 200 provides a browser 201 to access electronic data stored in the web server 300. The electronic device 200 can be a telephone, a tablet computer, a desk computer, or the like. The system 100 also can be installed and run on an electronic device or a web server. In the embodiment, the system 100 is installed on the electronic device 200.

The system 100 can include an identification unit 10, an obtaining unit 20, and a control unit 30.

The identification unit 10 can identify the identity of the user when a user opens a browser 201 to browse content from the web server 300. In at least one embodiment, the system 100 includes a storage unit 40 for storing the customized topics of users. The identification unit 10 also can determine whether the use's customized topics are stored in the storage unit 40 of the system 100. In one embodiment, the use's customized topics can include topics such as news and sports that the user prefers to display on the user's customized web page and the topics such as advertisements that the user wants to be shielded from the user's customized web page.

The obtaining unit 20 can obtain partial content of the web page from the web server 300 when the identification unit 10 determines the user's customized topics are stored in the system 100. The partial content is determined according to the user's customized topics of the web page. In at least one embodiment, the obtaining unit 20 only selects the content of the web page associated with the topics the user prefers to display on his or her customized web page.

The control unit 30 can create a customized web page for the user according to the obtained partial content, and display the created customized web page via the browser 201. In at least one embodiment, the control unit 30 determines a layout of the obtained partial content, and arranges the obtained partial content according to the determined layout. The determined layout of the obtained partial content determines the position of each of the customized topics arranged on the customized web page. In the embodiment, the created customized web page is a still web page including one or more blocks. Each block corresponds to a customized topic and displays contents of the customized topic. Contents of a same customized topic are arranged in a same block of the still web page.

The system 100 further can include a recognizing unit 50 and a determination unit 60.

The recognizing unit 50 can recognize a request command for customizing topics in response to an input operation of the user. In an embodiment, a menu item for triggering the customization of topics can be included in a menu that appears when the user clicks the right button of the mouse. The request command for customizing the content topics is created when a user selects or clicks the menu item for triggering the customization of topics. That is, the request command for triggering customization of topics can be created by operating a certain button or selects a certain menu item. In an alternative embodiment, the request command for triggering customization of topics can be created by a predefined gesture.

The determination unit 60 can determine the topics the user wants to customize in response to the user's operations, and store the determined topics in the storage unit 40. In at least one embodiment, after the customization of topics are triggered, the determination unit 60 determines the topics the user clicks or the mouse stops over a preset time length is that the user want to customize. In an alternative embodiment, the determination unit 60 determines the topics the user wants to customize according to keywords inputted by user.

The determination unit 60 also establishes a relationship between the identity of the user and the topics customized by the user, and further stores the established relationship in the storage unit 40.

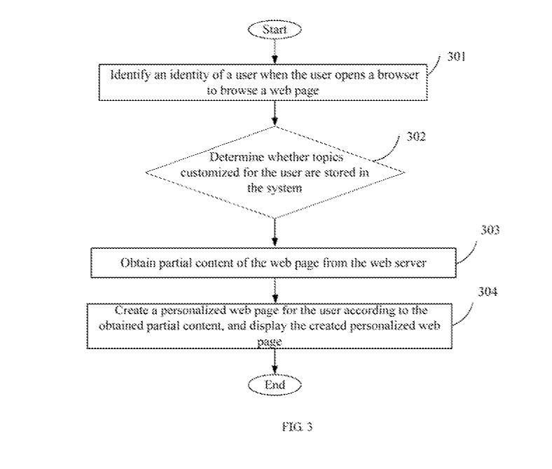

Referring to FIG. 3, a flowchart is presented in accordance with an example embodiment which is being thus illustrated. The example method 300 is provided by way of example, as there are a variety of ways to carry out the method. The method 300 described below can be carried out using the configurations illustrated in FIGS. 1 and 2, for example, and various elements of these figures are referenced in explaining example method 300. Each block shown in FIG. 3 represents one or more processes, methods or subroutines, carried out in the exemplary method 300. Additionally, the illustrated order of blocks is by example only and the order of the blocks can change according to the present disclosure. The exemplary method 300 can begin at block 301.

At block 301, the identification unit identifies identity of a user when the user opens a browser to browse content from the web page server.

At block 302, the identification unit determines whether topics customized by the user are stored in the system; if yes, the process goes to block 303, if no, the process ends.

At block 303, the obtaining unit obtains partial content of the web page from the web server. The obtained partial content is determined according to the user's customized topics of the web page.

In at least one embodiment, the obtaining unit only selects the partial content of the web page associated with the topics the user prefers to display on user's customized web page.

At block 304, the control unit creates a customized web page for the user according to the obtained partial content, and displays the created customized web page via the browser.

In at least one embodiment, the control unit determines a layout of the obtained partial content, and arranges the obtained partial content according to the determined layout. The layout of the obtained partial content is to determine the position of each of the customized topics arranged on the customized web page. In the embodiment, the created customized web page is a still web page including one or more blocks. Each block corresponds to a customized topic and displays contents of the customized topic. Contents of a same customized topic are arranged in a same block of the still web page.

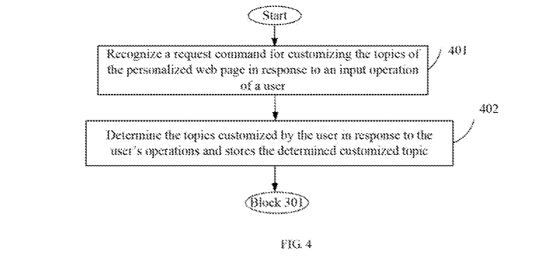

Referring to FIG. 4, in an alternative embodiment, the method shown in FIG. 3 and described above also can include following blocks before the block 301 of FIG. 3, which begins at block 401.

At block 401, the recognizing unit recognizes a request command for customizing the content topics in response to an input operation of the user.

At block 402, the determination unit determines the topics the user wants to customize in response to the user's operations and stores the determined customized topics in the storage unit.

In an alternative embodiment, the determination unit also establishes a relationship between the identity of the user and the topics customized by the user, and further stores the established relationship in the storage unit.

The embodiments shown and described above are only examples. Many details are often found in the art such as the other features of an electronic device or a web server. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A method for creating a customized web page, the method comprising:
identifying an identity of a user when the user opens a browser to browse content from a web server;
obtaining partial content of the web page from the web server, the obtained partial content being associated with topics customized by the user;
creating a customized web page according to the obtained partial content; and
displaying the created customized web page.

2. The method as claimed in claim 1, further comprising:
determining whether the topics customized by the user are stored in the web server; and
obtaining partial content of the web page from the web server if the topics customized by the user are stored in the web server.

3. The method as claimed in claim 2, wherein the topics customized by the user comprise the topics the user prefers to display on the customized web page and the topics the user wants to be shielded from the customized web page.

4. The method as claimed in claim 3, wherein obtaining partial content of the web page from a web server is to select the content of the web page associated with the topics the user prefers to display on the user's customized web page.

5. The method as claimed in claim 4, further comprising:
determining a layout of the selected partial content; and
arranging the selected partial content according to the determined layout.

6. The method as claimed in claim 5, wherein determining the layout of the selected content is determining the position of each of the customized topics arranged on the customized web page.

7. The method as claimed in claim 6, wherein the customized web page is a still web page including one or more blocks, each block corresponding to a customized topic and displaying contents of the customized topic, contents of a same customized topic being arranged in a same block of the still web page.

8. The method as claimed in claim 1, further comprising:
recognizing a request command for customizing the topics in response to an input operation of the user;
determining the topics the user wants to customize;
establishing a relationship between the identity of the user and the topics customized by the user; and
storing the relationship in the web server.

9. A web server for creating a customized web page, comprising:
an identification unit configured for identifying an identity of a user when the user opens a browser to browse content from a web server;
an obtaining unit configured for obtaining partial content of the web page from the web server, the obtained partial content being associated with topics customized by the user; and
a control unit configured for creating a customized web page according to the obtained partial content, and displaying the created customized web page.

10. The web server as claimed in claim 9, wherein the identification unit also is configured for determining whether the topics customized by the user are stored in the web server.

11. The web server as claimed in claim 10, wherein the control unit is also configured for determining a layout of the obtained partial content, and arranging the obtained partial content according the determined layout.

12. The web server as claimed in claim 11, wherein determining layout of the obtained content is to determine the position of each of the customized topics arranged on the customized web page.

13. The web server as claimed in claim 11, further comprising
a recognizing unit configured for recognizing a request command for customizing the topics in response to an input operation of the user; and
a determination unit is configured for determining the topics the user wants to customize, and establishing a relationship between the identity of the user and the topics customized by the user, and further storing the established relationship in the web server.

14. A system for creating a customized web page, comprising:
an identification unit configured for identifying an identity of a user when the user opens a browser to browse content from a web server;
an obtaining unit configured for obtaining partial content of the web page from the web server, the obtained partial content being associated with topics customized by the user; and
a control unit configured for creating a customized web page according to the obtained partial content, and displaying the created customized web page.

15. The system as claimed in claim 14, wherein the identification unit is also configured for determining whether the user's customized topics are stored in the system.

16. The system as claimed in claim 15, wherein the control unit is also configured for determining a layout of the obtained partial content, and arranging the obtained partial content according the determined layout.

17. The system as claimed in claim 16, wherein determining layout of the obtained content is to determine the position of each of the customized topics arranged on the customized web page.

18. The system as claimed in claim 17, further comprising:
a recognizing unit configured for recognizing a request command for customizing the topics in response to an input operation of the user; and
determination module is configured for determining the topics the user wants to customize, and establishing a relationship between the identity of the user and the topics customized by the user, and further storing the established relationship in a storage unit of the web server.
